(19) United States
(12) Patent Application Publication
(10) Pub. No.: US 2012/0003415 A1
(43) Pub. Date: Jan. 5, 2012

(54) BELTS FOR ELECTROSTATOGRAPHIC APPARATUS AND METHODS FOR MAKING THE SAME

(75) Inventor: Paul M. Fromm, Rochester, NY (US)

(73) Assignee: XEROX CORPORATION, Norwalk, CT (US)

(21) Appl. No.: 12/828,154

(22) Filed: Jun. 30, 2010

(51) Int. Cl. F16L 11/04; G03G 15/20

(52) U.S. Cl. 428/36.91; 399/329; 156/137

(57) ABSTRACT

The present embodiments are generally directed to a belt for use in an electrostatographic apparatus that is made by applying the substrate and various layers onto the inside of a mandrel, rather than on the outside of the mandrel. The method of the present embodiments allows formation of the belt from the outer layer in to the inner layers, which provides a more effective method of making the belt as well as a belt with enhanced properties. The tensile member of the belts comprises fibrous materials and is formed in place with the rest of the layers.

### CROSS REFERENCE TO RELATED APPLICATIONS

Reference is made to co-pending, commonly assigned U.S. patent application Ser. No. 12/493,780, the entirety of which is herein incorporated by reference.

### BACKGROUND

The presently disclosed embodiments relate generally to imaging devices that are useful in imaging apparatus members and components. More particularly, the embodiments pertain to a belt for apparatuses useful in electrostatographic apparatuses including printing, copying, scanning, faxing and the like, and digital apparatuses as well.

Some electrostatographic apparatuses include a nip formed by a belt and roll. In such apparatuses, media are fed to the nip and contacted by the belt and roll to treat marking material on media to form images on the media.

Fabrication of the flexible belts present several challenges because, for example, they need to be supported by a rigid structure and then subsequently removed from that structure. A mandrel, or any other similar object used to shape machined work, is commonly employed. The fit of the mandrel to the base substrate of the belt needs to be tight and ideally have no bumps, flats or discontinuities. Typical layers of elastomer or thermo-plastic are next flow-coated or sprayed onto the substrate fitted on the mandrel. Any sanding or surface finishing of the layers requires a very continuous surface. While these steps can tolerate some discontinuity, there is still desired objectives to achieve a more efficient process that can produce a belt having the optimal thickness, uniformity and smoothness.

It would thus be desirable to provide methods for making belts for apparatuses useful in electrostatographic processes that provide additional manufacturing options and exhibit enhanced properties, as well as belts made by those methods.

### SUMMARY

According to aspects illustrated herein, there is provided a method of making a belt for a an electrostatographic apparatus, comprising: forming a first layer of the belt using a first material comprising a first polymer applied on an inner surface of a mandrel, the first layer including a first outer surface facing the inner surface of the mandrel and a first inner surface of the first layer; forming a second layer of the belt using a second material comprising a second polymer applied over the first inner surface, the second layer including a second inner surface; forming a third layer of the belt using a third material comprising a second polymer embedded with a fibrous component applied over the second inner surface, the third layer including a third outer surface and a third inner surface; and removing the belt from the mandrel.

Another embodiment provides a process for forming a fuser belt for an electrostatographic apparatus, comprising: a first layer comprised of a first polymer, the first layer including a first outer surface and a first inner surface; a second layer comprised of a second polymer overlying the first inner surface, the second layer including a second inner surface; and a third layer comprised of a third polymer and a fibrous component embedded in the third polymer overlying the second inner surface, the third layer including a third inner surface, wherein the first layer of the belt is formed by applying the first polymer on an inner surface of a mandrel having a surface finish, the first outer surface having an as-molded surface finish based on the surface finish of the mandrel.

Yet another embodiment, there is provided a fuser belt for an electrostatographic apparatus, comprising: a first layer comprised of a first polymer, the first layer including a first outer surface and a first inner surface; a second layer comprised of a second polymer overlying the first inner surface, the second layer including a second inner surface; and a third layer comprised of a third polymer and a fibrous component embedded in the third polymer overlying the second inner surface, the third layer including a third inner surface, wherein the first layer of the belt is formed by applying the first polymer on an inner surface of a mandrel having a surface finish, the first outer surface having an as-molded surface finish based on the surface finish of the mandrel and the fibrous component being a material that can tolerate a temperature range of from about 25° C. to about 200° C.

### BRIEF DESCRIPTION OF THE DRAWINGS

For a better understanding, reference may be made to the accompanying figures.

FIG. 1 depicts an exemplary embodiment of an electrostatographic apparatus according to the present embodiments;

FIG. 2 depicts an exemplary embodiment of a fuser according to the present embodiments;

FIG. 3 depicts an exemplary embodiment of a mandrel according to the present embodiments;

FIG. 4 depicts the formation of an exemplary belt according to the present embodiments; and

FIG. 5 depicts an exemplary belt according to the present embodiments.

### DETAILED DESCRIPTION

In the following description, reference is made to the accompanying drawings, which form a part hereof and which illustrate several embodiments. It is understood that other embodiments may be used and structural and operational changes may be made without departure from the scope of the present disclosure.

In the present embodiments, the belt is manufactured by applying the substrate and various layers onto the inside of a mandrel, rather than on the outside of the mandrel. The method of the present embodiments allows formation of the belt from the outer layer in to the inner layers. In this manner, the outer layer that is formed replicates the finish of the mandrel from its contact with the surface of the mandrel, where as when flow-coated or sprayed by the convention method the surface finish is not controllable. The mandrel surface can be very smooth or a modestly rough surface depending on the desired belt finish. In addition, the resulting belt may remove the need for any additional sanding or surface finishing of the layers.

The present embodiments provide other benefits as well when compared to the convention method of making a belt. For example, the present embodiments provide a way to produce more uniform wall thickness layer, more centrifugal options to modify the layer composition (e.g., higher centrifugal speeds may be used since the layers are deposited inside the mandrel), wider temperature range for curing the outermost layer and also provide a simple manner in which to remove the finished belt from the mandrel. The present embodiments further provide means to produce a flared outside surface diameter of the belt with a cylindrical or straight inner surface, by cutting the inside surface of the mandrel with any desired non-cylindrical shape and spinning the liquid rubber to cause it to flow into the uniform diameter inner surface.

The present embodiments further provide a belt in which the inner layer is formed without the need for polyimide. By using other materials having long fibers, such as for example, fiberglass, nylon, polyester, carbon fibers, aramid, such as NOMEX (available from E.I. DuPont de Nemours and Company Performance Elastomers), steel, and the like, to form an inner, tensile layer, the high cost associated with polyimide is eliminated. In addition, the inner layer of the present embodiments impart a higher modulus and yield strength than those comprising polyimide. The thickness of the tensile layer may be thinner and thus the bending stress is lower and the fatigue life and flexibility are higher.

In embodiments, the method comprises forming a first layer of the belt using a first material comprising a first polymer applied on an inner surface of a mandrel, the first layer including a first outer surface facing the inner surface of the mandrel and a first inner surface; forming a second layer of the belt using a second material comprising a second polymer applied over the first inner surface, the second layer including a second inner surface; and removing the belt from the mandrel.

The disclosed embodiments further include a method of making a fuser belt for an apparatus useful in electrostatographic processes, such as for example, printing. The method comprises forming a first layer of the belt using a first material comprising a first polymer applied on an inner surface of a mandrel, the first layer including a first outer surface facing the inner surface of the mandrel and a first inner surface; forming a second layer of the belt using a second material comprising a second polymer applied over the first inner surface, the second layer including a second inner surface; forming a third layer of the belt from a third material comprising a third polymer applied over the second inner surface, the third layer including a third inner surface; and removing the belt from the mandrel.

In further embodiments, reinforcing fibers may be added to the second or third layers. In these embodiments, the reinforcing fibers are added to the second or third layers which are then cured into a belt and removed from the mandrel.

The disclosed embodiments further include a fuser belt for an apparatus useful for electrostatographic processes, such as for example, a printing apparatus. The fuser belt comprises a first layer comprised of a first polymer, the first layer including a first outer surface and a first inner surface; and a second layer comprised of a second polymer overlying the first inner surface, the second layer including a second inner surface. The first layer of the belt is formed by applying the first material on an inner surface of a mandrel having a surface finish. The first outer surface has an as-molded surface finish based on the surface finish of the mandrel.

As used herein the term “printing apparatus” encompasses any apparatus, such as a digital copier, bookmaking machine, multifunction machine, and the like, or portions of such apparatuses, that can perform a print outputting function for any purpose. The printing apparatuses can use various types of solid and liquid marking materials, and various process conditions to treat the marking material and form images on media.

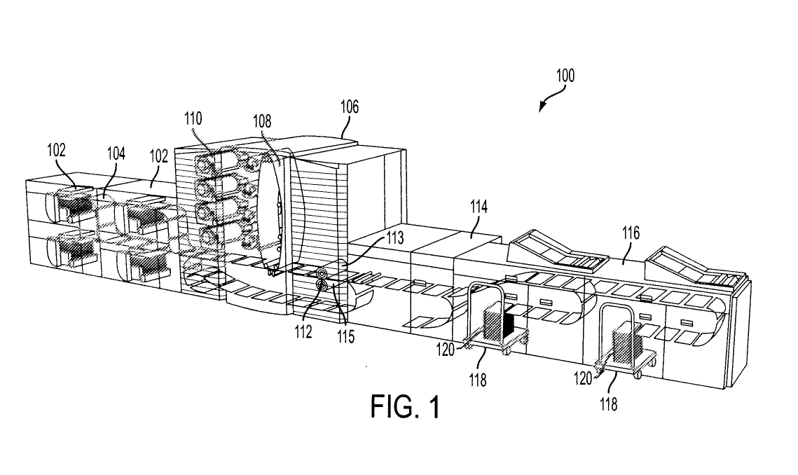

FIG. 1 illustrates an exemplary electrostatographic apparatus 100, as disclosed in U.S. Patent Application Publication No. 2008/0037069, which is incorporated herein by reference in its entirety. The electrostatographic apparatus 100 can be used to produce prints using media with various sizes and weights.

In embodiments, the electrostatographic apparatus 100 includes two media feeder modules 102 arranged in series, a printer module 106 adjacent the downstream media feeding module 102, an inverter module 114 adjacent the printer module 106, and two stacker modules 116 adjacent the inverter module 114.

In the electrostatographic apparatus 100, the media feeder modules 102 feed media to the printer module 106. In the printer module 106, a marking material (toner) is transferred from a series of developer stations 110 to a charged photoreceptor belt 108 to form toner images on the photoreceptor belt and produce color prints. The toner images are transferred to one side of respective media 104 fed through the paper path. The media are advanced through a fuser 112 including rolls 113, 115, which apply heat and pressure to fuse the toner images on the media. The inverter module 114 manipulates media exiting the printer module 106 by either passing the media through to the stacker modules 116, or by inverting and returning the media to the printer module 106. In the stacker modules 116, the printed media are loaded onto stacker carts 118 in stacks 120.

Methods for making belts for apparatuses useful in electrostatographic processes, such as for example, printing. Belts useful in such apparatuses are also provided. In embodiments, the belts are continuous. Embodiments of the apparatuses include a belt supported on rolls. The belt and a second member facing the belt, such as an external pressure roll, form a nip. Media are fed to the nip and contacted by the belt and second member. Embodiments of the apparatuses are constructed to treat marking material carried on the media. The marking material can be toner or ink in embodiments of the apparatuses. In embodiments, at least one of the belt and second member is heated in order to apply heat and pressure to the media at the nip to treat the marking material.

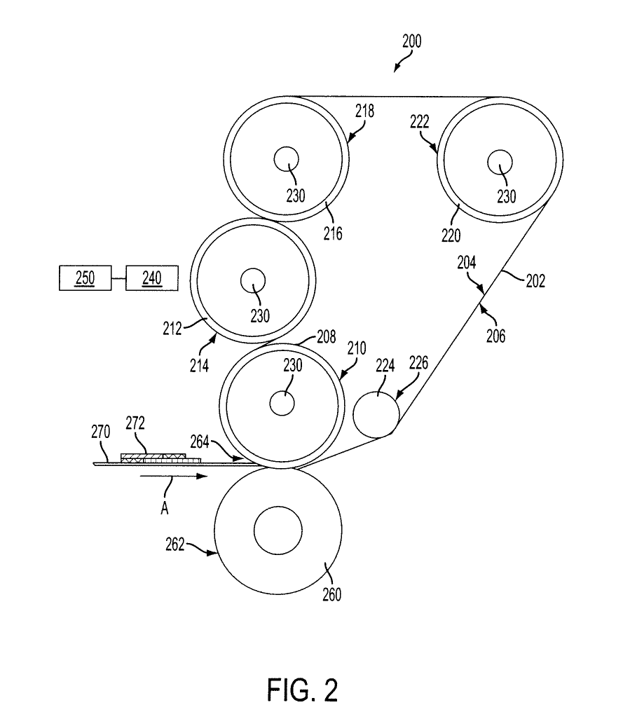

FIG. 2 illustrates an exemplary embodiment of an apparatus useful in electrostatographic processes. The illustrated apparatus is a fuser 200. Embodiments of the fuser 200 can be used in different types of electrostatographic apparatuses. For example, the fuser 200 can be used to replace the fuser 112 in the electrostatographic apparatus 100 shown in FIG. 1.

As shown in FIG. 2, the fuser 200 includes a continuous belt 202 having an inner surface 204 and an outer surface 206. The belt 202 is rotatable about a fuser roll 208, external roll 212, internal rolls 216, 220 and an idler roll 224. In other embodiments, in addition to the fuser roll 208, the fuser 200 can have different numbers, types and arrangements of rolls supporting the belt 202. In the fuser 200, the fuser roll 208, internal rolls 216, 220 and idler roll 224 include respective outer surfaces 210, 218, 222, 226 contacting the inner surface 204 of the belt 202, and the external roll 212 includes an outer surface 214 contacting the outer surface 206 of the belt 202.

The fuser roll 208, external roll 212 and internal rolls 216, 220 may each include an internal heat source 230 to heat the belt 202. In embodiments, the heat sources 230 can be, e.g., one or more axially-extending heating lamps connected to a power supply 240. The power supply 240 is connected to the controller 250 to control the supply of power to the heat sources 230. The heat sources 230 are actuated to heat the belt 202 to a temperature effective to treat marking material on media.

The fuser 200 further includes an external pressure roll 260 with an outer surface 262. The outer surface 262 and the outer surface 206 of the belt 202 form a nip 264. In embodiments, the pressure roll 260 includes a core and one or more layers overlying the core. The outer layer includes the outer surface 262. In embodiments, the core can be comprised of aluminum, or the like, and the overlying layer(s) of an elastically deformable material, such as silicone rubber, perfluoroalkoxy (PFA) copolymer resin, or the like.

FIG. 2 depicts a medium 270 with marking material 272 being fed to the nip 264 in the process direction A. In embodiments, the fuser roll 208 can be rotated counter-clockwise, and the external pressure roll 260 clockwise, to convey the medium 270 through the nip 264 in process direction A. The media can be paper sheets, transparencies, packaging materials, and the like. The media can be coated or uncoated.

Methods of making belts for apparatuses useful in electrostatographic processes and belts made by the methods are provided. In embodiments, the belts are continuous. The belts can be used, e.g., in the fuser 200, as well as in other apparatus useful for electrostatographic, including for example, printing. The belts are flexible and include two or more layers that provide selected physical, chemical and/or electrical properties in the belts. For example, embodiments of the belts can include an inner layer having the inner surface and an outer layer overlying the inner layer and having the outer surface. Other embodiments of the belts can include, e.g., an inner layer, an intermediate layer overlying the inner layer, and an outer layer overlying the intermediate layer. In such embodiments, the inner layer includes the inner surface of the belt, and the outer layer includes the outer surface of the belt.

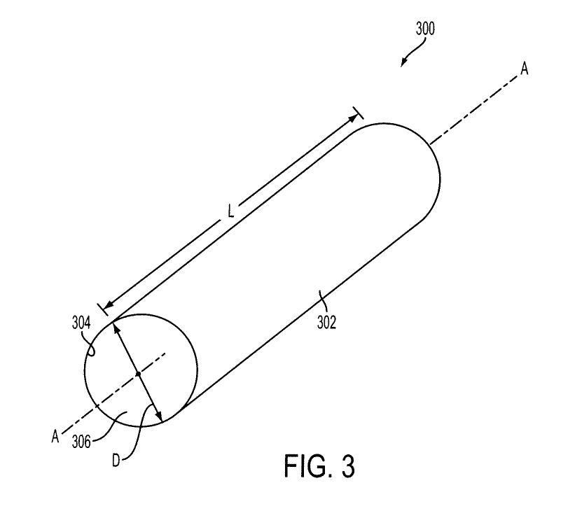

In embodiments, the belt is formed against the inner surface of a rigid mandrel including an internal cavity. FIG. 3 depicts an exemplary mandrel having a cylindrical, tubular configuration. The mandrel 300 includes an outer surface 302 and an inner surface 304 defining an internal cavity 306. In embodiments, the mandrel 300 is closed at one end to support the mandrel tube to a supporting shaft. A longitudinal axis A-A extends along the length, L, of the mandrel 300. Typically, the mandrel can have an inner diameter, D, of about 50 mm to about 320 mm, and an inner circumference of about 150 mm to about 1000 mm, or more depending on the size of the belt required.

The mandrel can be comprised of any suitable metal, such as steel, stainless steel, aluminum, aluminum alloys, or the like. Other non-metallic materials that can withstand the temperatures reached during sintering or curing of the layers of the belts can be used, such as polymers, composites or ceramics.

The outer surface of the belts formed using the mandrels have an as-formed finish that is dependent on the finish of the inner surfaces of the mandrels. For example, the inner surface 304 of the mandrel 300 can be smooth to produce a smooth surface finish for the outer surface of the belt. In other embodiments, the inner surface 304 of the mandrel 300 can be roughened or textured by a mechanical technique (e.g., sanding or blasting) and/or a chemical technique (e.g., chemical etching) to produce a corresponding roughened or textured finish for the outer surface of the belt. Depending on the surface finish of the inner surface 304 of the mandrel 300, the outer surface of the belt can have, e.g., a micro-texture or a finer nano-texture. In embodiments, the micro-textured surface of the mandrel 300 can includes features having a maximum dimension of less than about 10 microns. A nano-textured surface of the mandrel 300 can include features having a maximum dimension of less than about 10 nano-meters. A belt micro-texture can enhance stripping of media from the outer surface of the belt, and a belt nano-texture can affect the wetting of marking materials and release agents. The surface finish formed on the belt based on the finish of the inner surface of the mandrel can be produced without performing any secondary operations on the belt.

In embodiments, the respective layers of the belt are formed using selected materials that provide the desired combination of physical, chemical and/or electrical properties at different regions across the belt thickness. In embodiments, the outer layer of the belt is formed first on the inner surface of the mandrel. Then, one or more additional layers are formed over the inner surface of the outer layer. The innermost layer forms the inner surface of the belt.

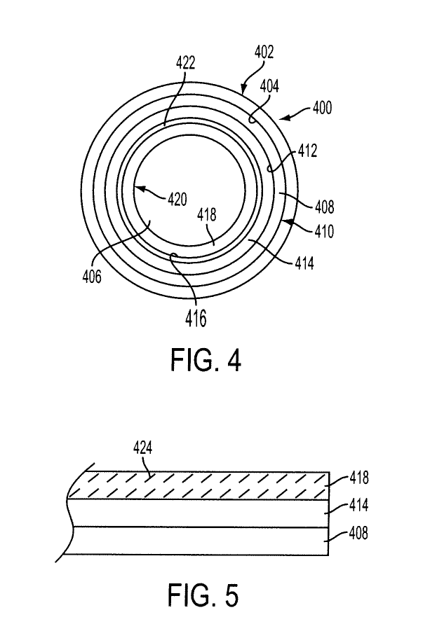

FIG. 4 depicts the forming of an exemplary three-layered belt on the inner surface 404 (which is represented by 304 in FIG. 3) of a mandrel 400 including an internal cavity 406 and an outer surface 402. FIG. 4 shows an outer layer 408 formed on the inner surface 404 of the mandrel 400. The outer layer 408 includes an outer surface 410 and an inner surface 412. The outer surface 410 forms the outer surface of the as-formed belt.

The outer layer 408 can typically have a thickness of about 10 micrometers to about 50 micrometers. In embodiments, the outer layer 408 comprises a polymer having sufficiently-high flexibility in the belt. The polymer can be, e.g., a fluoropolymer. In embodiments, the material of the outer layer 408 desirably provides the properties of low surface energy, high abrasion resistance, low modulus of elasticity (low stiffness), and a coefficient of friction and surface energy sufficiently low to reduce adherence of marking materials, such as toner, to the outer surface of the belt. A suitable material for the outer layer 408 is TEFLON PTFE (polytetrafluoroethylene) available from E. I. du Pont de Nemours and Company. This material has a maximum operating temperature of about 260° C. TEFLON PTFE can be applied to mandrels made of metals, such as carbon steel, aluminum, stainless steel and steel alloys, and to non-metallic materials, such as glass, fiberglass, rubber, and plastics, that are capable of withstanding the curing temperature. Alternatively fluoropolymers such as VITON (available from DuPont Performance Elastomers), can be applied to mandrels made of metals, such as carbon steel, aluminum, stainless steel, steel alloys, and the like, and to non-metallic materials, such as glass, fiberglass, rubber, plastics, and the like, which are capable of withstanding the curing temperature.

In embodiments, the material used to form the outer layer 408 of the belt has the highest curing or sintering temperature of the materials used to make the structural layers of the belt. Thermoplastic coatings are sintered and thermoset materials are cured. A layer of thermoplastic particles is applied to a surface using a dry powder application or wet coating with the particles suspended in a liquid that is evaporated away. The particles are then heated until they melt and flow together to form a continuous film. Using a high temperature to sinter a thermoplastic outer layer can result in this layer having a low porosity (high density) that approaches 0 percent porosity (full density) similar to an extruded material. The molecules of the thermoset material cross-link to each other when heat is applied and/or a catalyst is present. Also, by using a material having the highest curing or sintering temperature to form the outer layer, the curing or sintering temperature range for the outer layer can be increased to an optimal value without risk of damaging other layers of material forming the belt, which increases the number of materials that are suitable for making the outer layer.

The inner surface 404 of the mandrel 400 can be coated with a mold release agent, such as a wax, fluorocarbon, or the like, to enhance removal of the belt from the mandrel after the molding process is completed.

In other embodiments, the outer layer 408 of the belt can comprise a material that has a higher surface energy than TEFLON PTFE, or the like, but which provides one or more desirable properties, such as high abrasion resistance. An exemplary group of polymers that provides these properties is the fluoroelastomers, such as VITON fluoroelastomer available from E.I. DuPont de Nemours and Company Performance Elastomers. This material has a heat resistance of about 250° C. To reduce adherence of marking materials to the outer surface of the outer layer, a sufficient amount of a release agent, such as silicone oil, or the like, can be applied to the outer surface 410 of the outer layer 408.

The outer layer 408 typically has a thickness in the finished belt of about 10 micrometers to about 50 micrometers to allow the outer layer 408 to strain around image topography on media and media topography.

In embodiments, the outer layer 408 can comprise two or more layers. For example, the outer layer can comprise a first outer layer formed on the inner surface 404 of the mandrel 400, and a second outer layer formed on the inner surface of the first outer layer and forming the inner surface 412 of the outer layer 408. The two outer layers can have different compositions and properties from each other. For example, the first outer layer can have a lower surface energy and a lower thermal conductivity than the second outer layer. The two outer layers can have the same or different thicknesses. In embodiments, the first and second layers can comprise the same base material and contain different amounts of additives to give the layers different properties. When the layers are applied dry and substantially do not mix, they can be sintered or cured in one step. When the first and second layers are applied wet, they are likely to mix. The first layer can be dried and/or partially cured or sintered before the second layer is applied. As the base material is the same in the first and second layers, adhesives do not need to be used between the layers.

FIG. 4 also shows an intermediate layer 414 formed on the inner surface 412 of the outer layer 408. The intermediate layer 414 underlies the outer layer 408 in the as-formed belt. The intermediate layer 414 has an inner surface 416. In embodiments, the intermediate layer 414 can comprise a polymer that has a sufficiently-high coefficient of thermal conductivity to enable sufficient heat transfer within the belt, a high specific heat to store energy sufficiently, and a sufficiently-low modulus of elasticity (i.e., low stiffness) in the radial direction (i.e., thickness dimension of the intermediate layer) to deform sufficiently to be able to conform to image topography on media and to media surface topography (roughness). An exemplary material that can be used to form the intermediate layer 414 is silicone rubber.

In embodiments, the polymer used to form the intermediate layer 414 of the belt can have a lower curing or sintering temperature than the polymer of the outer layer 408. This feature is desirable in order to avoid adversely affecting the structure and/or properties of the outer layer 408 during heating of the material of the intermediate layer 414 while being cured inside the mandrel.

The intermediate layer 414 can typically have a thickness of about 50 micrometers to about 1000 micrometers. In other embodiments, the intermediate layer can have a thickness of about 10 micrometers to about 50 micrometers.

FIG. 4 further shows an inner layer 418 (base layer) formed on the inner surface 416 of the intermediate layer 414. The inner layer 418 underlies the intermediate layer 414 in the as-formed belt, and serves as a layer that provides tensile strength. The inner layer 418 has an inner surface 420 forming the inner surface of the belt. In embodiments, the inner layer 418 can comprise a polymer that has a sufficiently-high modulus of elasticity to provide a sufficiently-high circumferential stiffness to allow the belt to be tensioned and undergo a small circumferential elongation of less than about 5 percent, less than about 3 percent, or less than about 1 percent, when installed on the supporting rolls of the fuser.

To provide the above-described properties in the inner layer 418, long fibers 424 are formed in the polymer layer, as shown in FIG. 5. In embodiments, the inner layer comprises fiberglass, carbon fibers, aramid fibers (such as KEVLAR and NOMEX), steel fibers, polyimide fibers and the like, and mixtures thereof, for curing and use at higher temperatures. In further embodiments, the inner layer comprises a material selected from the group consisting of nylon, polyester, MYLAR, and the like, and mixtures thereof, for curing and use at lower temperatures. In specific embodiments, the polyester fibers are DACRON fibers can be used. DACRON is a condensation polymer obtained from ethylene glycol and terephthalic acid. Its properties include high tensile strength, high resistance to stretching, both wet and dry, and good resistance to degradation by chemical bleaches and to abrasion. DACRON fiber is available from E.I. du Pont de Nemours and Company.

In the present embodiments, the layer materials selected will be able to tolerate temperatures that range from room temperature to about 200° C. In embodiments, fiber glass, carbon fiber, steel fibers and aramid fibers will be used due to high heat stability. Such material can tolerate temperatures of over 150° C. Polyesters and nylons are better suited to temperatures of less than 150-180° C. Thus, in particular embodiments, the fibrous component is selected from the group consisting of fiberglass, carbon fibers, aramid fibers, steel and mixtures thereof, for curing and use at temperatures higher than about 150° C., while the fibrous component is selected from the group consisting of nylon, polyester, natural fibers, such as cotton and flax (linen) threads (twisted entangled bundles of short fibers), and mixtures thereof, for curing and use at temperatures no higher than about 150° C.

In embodiments, the long fibers are present in the inner layer in an amount of from about 0.5 strands/mm of width to about 10 strands/mm, or from about 10 percent to about 75 percent by weight of the total weight of the inner layer. A strand (or tow) is a small bundle of thousands of fibers. In embodiments, the polymer is present in the inner layer in an amount of from about 90 percent to about 25 percent, percent by weight of the total weight of the inner layer.

The inner layer 418 of the present embodiments provides the desired properties with much reduced costs of other conventional belts by avoiding the use of polyimide for the inner layer 418. In addition, the tensile layer of the present embodiments impart a higher modulus and yield strength than those comprising polyimide. Polyimide tensile strength is from about 200 to about 400 MPa, depending on the exact formulation used with a tensile modulus of from about 8300 to about 4000 MPa. In embodiments, the tensile strength of the fibers, for example, glass, is from about 1400 to about 2000 MPa, or for the layer from about 100 to about 1000 MPa, depending on how much fiber is used. The tensile modules of glass is around 72 GPa. Carbon fiber is on the higher end of the spectrum while aramid fiber like KEVLAR is on the lower end of the spectrum. Due to the higher strength and stiffness of the fiber used, as compared to the typical polyimide used, a much thinner tensile layer may be employed and thus the bending stress is lower and the fatigue life and flexibility are higher.

The polymer used to embed the reinforcing fibers is, in embodiments, to be from the same general family of elastomers as that used in the intermediate layers to promote adhesion, utilize similar curing temperatures and have similar thermal expansion properties. The exact filler content could be optimized for fiber embedding. Low viscosity may be used to improve wetting of the fibers and self-leveling.

In particular embodiments, the long fibers 424 used have a length of from about 50 percent to about 150 percent of the inner circumference of the mandrel. The long fibers 424 may be fed via a chopper head at a speed synchronous with the mandrel rotation. In embodiments, the long fibers may be cut at about 1.2 of the mandrel circumference to ensure they will lay tight around the circumference and in contact with the wall. However, if the speed is matched exactly the same, the fibers need not be cut. The traverse speed of the fiber-spewing head will determine the helix angle of the long fibers. Helix angle will affect circumferential and axial stiffness of the belt and the change in width as the belt is stretched. Similarly, thickness or fiber density will also affect stiffness. Incorporating layers of fiber with different helix angles will help make a belt uniformly stiff.

After the fibers are laid-out and set in the inner layer 418, the mandrel is spun at a rotational speed such that the centrifugal forces will move the portion of the fibers that are not in full contact with the inner surface such as the case where the fiber feed is slower than the speed of the inner surface against the wall, while sliding part of the fiber around the mandrel. The rotation of the mandrel will also sink the long fibers 424 into the polymer of the inner layer 418. Subsequently, the solvent is evaporated from polymer layers and at least partially cured while the assembly is still in motion to prevent gravity from causing thickness variations. In certain situations where the fiber may float, a small amount of additional polymer may then be added over the fiber after the polymer of the inner layer 418 stiffens, and the mandrel subsequently spun slowly.

In embodiments, the material used to form the inner layer 418 of the belt can have a lower curing or sintering temperature than the materials of the outer layer 408 and intermediate layer 414 to avoid adversely affecting the structure and/or properties of the outer layer 408 or intermediate layer 414 during curing or sintering of the material of the inner layer 418. Fluoroelastomers and silicone elastomers typically cure at a temperature range of from about 200 to about 250° C. while polyimide sinters in a range of about 350° C.

In further embodiments, the inner surface 420 of the inner layer 418 may be sprayed with TEFLON powder heated in a very hot air stream, for example, at from about 500° F. to about 930° F. or from about 260° C. to about 500° C. This subsequent step reduces friction of the inside of the belt on items that the belt may need to slide on. Spraying of the thermoplastic Teflon in hot air or plasma will allow reasonable sintering of the particles without subjecting the entire thickness of the elastomers to excessive temperatures.

In further embodiments, adhesive layers can be added as needed. In one embodiment, as shown in FIG. 4, an adhesive layer 422 is applied on the intermediate layer 414. The adhesive layer 422 facilitates adherence of the inner layer 418 to the intermediate layer 414. This adhesive may be needed if the materials in these two layers is not nearly the same or if the intermediate layer is allowed to fully cure prior to the application of the inner layer 418.

In embodiments, at least one layer of the multi-layered belts can contain a filler material that provides desired physical, chemical and/or electrical properties in the belts. For example, the filler can be carbon, metal oxide such as aluminum oxide, copper oxide, titanium dioxide, and the like and mixtures thereof. In embodiments, the filler material is in particle form. These filler particles can be on the micrometer or nanometer scale. These filler particles can also have shapes of approximately spherical, flakes of rods. For example, the particles can be fibers having a high aspect ratio, such as cylindrical- or rod-shapes, and the like. Exemplary rod-shaped particles can have a length of about 1.0 micrometers to about 50 micrometers and a diameter of about 0.1 nm to about 5 nm. In embodiments, the particles can have a loading, by volume, of about 2 percent to about 20 percent, in respective layers containing the particles. Inside the mandrel, the rod-shaped particles can be oriented in the radial direction in respective layers. That is, the length dimensions of the filler particles can be oriented substantially perpendicular to the outer surface of the layer(s) containing them. For example, carbon rods or nano tubes or other materials with high thermal conductivity can be oriented in the radial direction in at least one layer to increase thermal conductivity in the thickness direction of the belt.

The belts can typically have a width of about 350 mm to about 450 mm, and a length (or circumference) of about 500 mm to about 1000 mm, or even longer.

The methods of making flexible belts on the inside of a mandrel include forming the outer layer of the belt first on the inner surface of mandrel, and then forming one or more additional layers of material overlying the inner surface of the outer layer, i.e., from the outside towards the inside of the finished belt. The layers comprise materials selected to provide the desired properties in the belt, as well as having desired processing characteristics.

In an exemplary embodiment of the methods, a mold release agent is applied to the inner surface of a mandrel. The mandrel has an inner diameter of about 100 mm to about 1000 mm. Then, a fluoropolymer, such as PTFE, FEP, and other TEFLON-like materials can be used. In addition, a fluoroelastomer such as copolymers of two of vinylidene fluoride, hexafluoropropylene and tetrafluoroethylene; terpolymers of vinylidene fluoride, hexafluoropropylene and tetrafluoroethylene, and tetrapolymers of vinylidene fluoride, hexafluoropropylene, tetrafluoroethylene and a cure site monomer can be used. These fluoroelastomers are sometimes sold by DuPont under the tradename VITON. In embodiments, either a fluoropolymer or fluoroelastomer, is applied to the inner surface of the mandrel. The applied material is heated to solidify the material and form the outer layer of the belt. The outer layer has a thickness of about 10 micrometers to about 50 micrometers. The heating can produce full curing or partial curing of the outer layer.

A material such as silicone, or the like, is then applied over the inner surface of the outer layer. This material is then heated to solidify the material and form the intermediate layer of the belt. The intermediate layer has a thickness of about 50 micrometers to about 500 micrometers. The material used to form the intermediate layer of the belt is heated to an equal or lower temperature than used to solidify the material of the outer layer. The heating can produce full curing or partial curing of the intermediate layer.

Then, another material is applied to the inner surface of the intermediate layer. Reinforcing fibers are added to this layer while it is liquid. This material is then heated to solidify the material and form the inner layer. The inner layer has a thickness of about 10 μm to about 100 μm, in the finished belt. The material used to form the inner layer of the belt has an equal or lower curing or sintering temperature than the material used to form the intermediate layer.

In embodiments, an adhesive layer can be applied between the outer layer and intermediate layer, and/or between the intermediate layer and the inner layer to enhance adhesion between these adjacent layers.

The as-formed belt can be removed from the internal cavity of the mandrel by any suitable technique. For example, the belt can be peeled from the inner surface of the mandrel by moving the belt to a second mandrel or a rod. The rod can have a diameter about 50 percent or less of the mandrel to provide space to maneuver the rod and belt inside of the mandrel. The belt peeling process can begin by directing a compressed gas flow between the inner surface of the mandrel and outer surface of the belt. In embodiments, the technique used to peel the finished belt from the inner surface of the mandrel does not crease the belt structure. The second mandrel or rod is used to wind the belt to a smaller size and then withdraw the belt from the mandrel the belt is formed on.

In embodiments, the inner surface of any one of the layers of the belt can be mechanically and/or chemically treated to have a desired surface finish. For example, the inner surface of the outer layer can be roughened using an abrasive surface, such as a sanding drum, to promote adhesion of the intermediate layer to the outer layer. Likewise, the inner surface of the intermediate layer can be roughened to promote adhesion of the intermediate layer to the inner layer. The inner surface of the inner layer can be finished to have a smooth surface, such as by rolling a smooth hard roller around the inner surface as the inner layer is solidifying.

In embodiments, a liquid release agent can be used to enhance removal of the belt from the mandrel.

In embodiments, the materials used to form successive layers of the belt can be poured into the mandrel and the mandrel rotated to spread the material out to produce layers having substantially-uniform respective thicknesses. For example, the thickness variation of layers can be less than about 10 percent, such as less than about 5 percent. The uniformity of the layer thicknesses may be improved by high-speed spinning of the mandrel.

For polymers that have higher viscosity, flow coating techniques can be used to introduce the material inside of the mandrel. Liquid spray methods can also be used to apply the materials to the inner surface of the mandrel and/or to previously-sprayed layers inside the mandrel.

One or more fillers can be incorporated into one or more layers of the belts formed by coating or casting techniques. In such embodiments, centrifugal separation or orientation of fillers added to the layers can be used. Centrifugal techniques allow the formation of polymer-rich or polymer-poor regions within a given layer (i.e., a non-uniform distribution of the filler in the thickness dimension of the layer), and/or a desired orientation of filler particles (e.g., a radial orientation) during formation in the mandrel. For example, a polymer composition containing filler used to form a layer of the belt can be poured into the mandrel while the mandrel is slowly rotated. The mandrel can be heated to start to gel, stiffen or crosslink the polymer composition. Then, the rotational speed of the mandrel can be increased to cause more filler to move toward the inside of the partially-cured region of the filler-containing layer (i.e., toward the inner surface of the mandrel), producing a gradient of the filler concentration within the layer. Fillers having different densities can be incorporated into respective layers of the belt. For example, fillers with different densities can be incorporated within the same layer of the belt. When the filler particle density is less than that of the matrix polymer material used to form a layer, the filler particles tend to move inwardly toward the center of the mandrel as the mandrel is rotated. When the filler particle density is greater than that of the matrix polymer material used to form a layer, the filler particles tend to move outwardly toward the inner surface of the mandrel as the mandrel is rotated. In embodiments, a mixture of filler particles having different densities (e.g., particles having a higher density than the matrix polymer material and particles having a lower density than the matrix polymer material) can be incorporated into a layer of the belt formed by a centrifugal technique to produce a distribution of the particles in the thickness direction of the layer. The filler particles having different densities can provide different properties in the thickness direction of the layer.

Embodiments of the belts including combinations of layers that are resistant to creasing can be turned inside-out after being formed inside mandrels. In such embodiments, a first material used to form the belt inner layer (e.g., long fibers) is first applied to the inner surface of the mandrel, then a second material used to form the belt intermediate layer (e.g., silicone) is applied to the inner surface of the layer formed with the first material, and then a third material used to form the belt outer layer (e.g., a fluoropolymer or fluoroelastomer) is applied to the inner surface of the layer formed with the second material. Then, the belt is turned inside-out. In such embodiments, the belt surface that contacts media at the nip in fusers is “as cast” or ground, not “as molded.”

Forming belts inside-out is desirable for making belts in which the conventionally first layer requires a higher a higher curing or sintering temperature than the materials used to form the remaining one or more layers of the belt. By forming the belts inside-out, the curing of the subsequent layers does not interfere with the already cured layers. In addition, in the present embodiments, the curing temperatures of the inner layer comprising the long fibers and the intermediate layer have comparable curing temperatures.

Although the above description is directed toward fusers used in xerographic printing, it will be understood that the teachings and claims herein can be applied to any treatment of marking material on a medium. For example, the marking material can be toner, liquid or gel ink, and/or heat- or radiation-curable ink; and/or the medium can utilize certain process conditions, such as temperature, for successful xerographic printing. The process conditions, such as heat, pressure and other conditions that are desired for the treatment of ink on media in a given embodiment may be different from the conditions suitable for xerographic fusing.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

All the patents and applications referred to herein are hereby specifically, and totally incorporated herein by reference in their entirety in the instant specification.

It will be appreciated that several of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A method of making a belt for a an electrostatographic apparatus, comprising:
forming a first layer of the belt using a first material comprising a first polymer applied on an inner surface of a mandrel, the first layer including a first outer surface facing the inner surface of the mandrel and a first inner surface of the first layer;
forming a second layer of the belt using a second material comprising a second polymer applied over the first inner surface, the second layer including a second inner surface;
forming a third layer of the belt using a third material comprising a second polymer embedded with a fibrous component applied over the second inner surface, the third layer including a third outer surface and a third inner surface; and
removing the belt from the mandrel.

2. The method of claim 1, wherein forming the first layer of the belt further comprises heating the first material to a first temperature to solidify the first material, forming the second layer of the belt further comprises heating the second material to a second temperature that is equal to or lower than the first temperature to solidify the second material over the first layer, and forming the third layer of the belt further comprises heating the third material to a third temperature that is equal to or lower than the first temperature to solidify the third material over the second layer.

3. The method of claim 2, wherein the first temperature, second temperature and third temperature are substantially the same.

4. The method of claim 1, wherein the fibrous component is selected from the group consisting of fiberglass, carbon fibers, aramid fibers, nylon, polyester, steel and mixtures thereof.

5. The method of claim 4, wherein the fibrous component is selected from the group consisting of fiberglass, carbon fibers, aramid fibers, steel and mixtures thereof, for curing and use at temperatures higher than about 150° C.

6. The method of claim 4, wherein the fibrous component is selected from the group consisting of nylon, polyester, cotton, flax, and mixtures thereof, for curing and use at temperatures no higher than about 150° C.

7. The method of claim 1, wherein the first outer surface forms the outer surface of the belt and the third inner surface forms the inner surface of the belt.

8. The method of claim 1, wherein removing the belt from the mandrel comprises turning the belt inside-out resulting in the first outer surface forming the inner surface of the belt and the third inner surface forming the outer surface of the belt.

9. The method of claim 1, wherein the fibrous component has a length of from about 50 percent to about 150 percent the length of the inner circumference of the mandrel.

10. The method of claim 1, wherein the first polymer is selected from the group consisting of a fluoropolymer and a fluoroelastomer, the second polymer is a silicone, and the third polymer is silicone.

11. The method of claim 1, wherein the first, second and third polymers are the same.

12. The method of claim 1, wherein the first layer is formed by applying the first material to the inner surface of the mandrel and rotating the mandrel to distribute the first material on the inner surface to a substantially uniform thickness, and the second layer is formed by applying the second material to the first inner surface of the first layer and rotating the mandrel to distribute the second material on the first inner surface of the first layer to a substantially uniform thickness.

13. The method of claim 1, wherein the third layer is formed by applying the third material to the second inner surface, setting the fibrous component in the third material, and rotating the mandrel to distribute the third material on the second inner surface to a substantially uniform thickness with the fibrous component being embedded in the third material.

14. The method of claim 1, wherein the belt further comprises an adhesive layer formed between the first and second layers or the second and third layers.

15. The method of claim 1 further comprising spraying polytetrafluoroethylene powder in a hot air stream on the third inner surface.
removing the belt from the mandrel.

16. A fuser belt for an electrostatographic apparatus, comprising:
a first layer comprised of a first polymer, the first layer including a first outer surface and a first inner surface;
a second layer comprised of a second polymer overlying the first inner surface, the second layer including a second inner surface; and
a third layer comprised of a third polymer and a fibrous component embedded in the third polymer overlying the second inner surface, the third layer including a third inner surface, wherein the first layer of the belt is formed by applying the first polymer on an inner surface of a mandrel having a surface finish, the first outer surface having an as-molded surface finish based on the surface finish of the mandrel.

17. The fuser belt of claim 1, wherein the first layer of the belt is formed by heating the first polymer to a first temperature to solidify the first polymer, the second layer of the belt further is formed by heating the second polymer to a second temperature lower than the first temperature to solidify the second polymer over the first layer, and the third layer of the belt further comprises heating the third polymer to a third temperature lower than the first temperature to solidify the third polymer over the second layer.

18. The fuser belt of claim 17, wherein the first temperature, second temperature and third temperature are substantially the same.

19. The fuser belt of claim 16, wherein the fibrous component is selected from the group consisting of fiberglass, carbon fibers, carbon powder, aramid fibers, nylon, polyester, steel, and mixtures thereof.

20. The fuser belt of claim 16, wherein the fibrous component has a length of from about 50 percent to about 150 percent the length of the inner circumference of the mandrel.

21. A fuser belt for an electrostatographic apparatus, comprising:
a first layer comprised of a first polymer, the first layer including a first outer surface and a first inner surface;
a second layer comprised of a second polymer overlying the first inner surface, the second layer including a second inner surface; and
a third layer comprised of a third polymer and a fibrous component embedded in the third polymer overlying the second inner surface, the third layer including a third inner surface, wherein the first layer of the belt is formed by applying the first polymer on an inner surface of a mandrel having a surface finish, the first outer surface having an as-molded surface finish based on the surface finish of the mandrel and the fibrous component being a material that can tolerate a temperature range of from about 25° C. to about 200° C.

22. The fuser belt of claim 21, wherein the inner surface of the mandrel has a micro-texture or a nano-texture which is formed in the first outer surface.
